(19) United States
(12) Patent Application Publication
(10) Pub. No.: US 2011/0121115 A1
(43) Pub. Date: May 26, 2011

(54) AGITATOR BALL MILL

(75) Inventors: Frank Ronald Lang, Muttenz (CH); Roger Habegger, Lupsingen (CH)

(73) Assignee: Willy A. Bachofen AG, Muttenz (CH)

(21) Appl. No.: 12/948,233

(22) Filed: Nov. 17, 2010

(30) Foreign Application Priority Data
Nov. 25, 2009 (EP) 09177022.2

(51) Int. Cl. B02C 17/14

(52) U.S. Cl. 241/178

(57) ABSTRACT

An agitator ball mill for finely grinding or dispersing a material comprises a grinding chamber for accommodating grinding bodies and for accommodating the grinding material. The grinding chamber has an inlet for the grinding material and is provided with an agitator which can be driven in rotation and has agitating means for moving the grinding bodies and the grinding material. A separating arrangement for separating off the grinding bodies from the ground material is arranged in the grinding chamber. The grinding chamber also has a product outlet for the material which has been ground and freed from grinding bodies, wherein the ground material passes through the separating arrangement into the product outlet. The separating arrangement is designed as a sedimentation centrifuge which can be driven in rotation and has an axial entrance, or an entrance which is at least in the vicinity of the axis, for the material intermixed with the grinding bodies.

### CROSS REFERENCE TO RELATED APPLICATIONS

Foreign priority benefits are claimed under 35 U.S.C. §119(a)-(d) or 35 U.S.C. §365(b) to European Application No. 09177022.2, filed Nov. 25, 2009 which is hereby incorporated by reference in its entirety.

### BACKGROUND

Agitator ball mills are used, for example, for comminuting or dispersing solids in a liquid phase, in particular for nanotechnology products and fine-grinding-technology products, for example for dye suspensions, paints, inks, ceramics, agrochemicals, filler suspensions, cosmetics, foods, pharmaceuticals or microorganisms.

In such agitator ball mills, material which is to be ground, or dispersed in a liquid, is introduced into the grinding chamber through an inlet, and is ground or dispersed in this grinding chamber by means of grinding bodies located therein. The material here is moved gradually through the grinding chamber, whereupon the ground or dispersed material is led out through a separating arrangement which restrains the grinding bodies, e.g. through a dynamic separating gap or through a slotted screen, and then through an outlet. The basic functioning of such agitator ball mills is known and described, for example, in EP 0 627 262 or DE 2 215 790.

Agitator ball mills make use of various separating techniques in order to separate the ground or dispersed material (product) from the grinding bodies. Examples of these techniques are dynamic separating gaps, which comprise a rotor and a stator, and screens, e.g. slotted screens. On account of the greater through-passage surface area, it is generally possible to realize a higher throughput by using screens. In the case of fine-grinding bodies (diameter 0.2 mm and less), however, very narrow slotted screens are necessary and the associated loss in pressure is very high. Accordingly, the throughputs which can be achieved are limited. In addition, particles of the material to be ground and grinding bodies can be deposited on the screen within an extremely brief period of time, and this can result in blockage of the mill.

EP 0 771 591 and EP 1 468 739 describe the grinding bodies being separated off using classifying wheels in which mechanisms similar to those in air classifiers operate and, correspondingly, vanes are installed. The product/grinding-body mixture has to be fed there by way of a product pump counter to the centrifugal force of the classifying wheel. Whereas the grinding bodies are centrifuged back into the grinding space by the classifying action, the product passes into the centre of the classifying wheel and to the product outlet. However, on account of the vanes installed, the wheels act simultaneously as powerful centrifugal pumps, which build up a correspondingly high pressure in the grinding space and thus make it difficult to establish a grinding process which is stable over a long period. In addition, the product pump has to generate a correspondingly relatively high pressure in order to feed the grinding material through the mill.

### SUMMARY

In one aspect, an agitator ball mill of the type mentioned in which the afore-mentioned problems in respect of separating off grinding bodies no longer occur or, at least, are vastly reduced is disclosed. In particular, it should be possible to ensure that fine grinding bodies are separated off without the afore-mentioned disadvantages.

In one embodiment, the agitator ball mill for finely grinding or dispersing a material comprises a preferably rotationally symmetrical grinding chamber for accommodating grinding bodies and for accommodating the material which is to be ground or dispersed. The grinding chamber has an inlet for the material which is to be ground or dispersed and is provided with an agitator which can be driven in rotation and has at least one agitating means for moving the grinding bodies and the material which is to be ground or dispersed. A separating arrangement for separating off the grinding bodies from the ground or dispersed material is arranged in the grinding chamber. The grinding chamber also has a product outlet for the material which has been ground or dispersed and freed from grinding bodies, wherein the ground or dispersed material passes through the separating arrangement into the product outlet. The separating arrangement is designed as a sedimentation centrifuge which can be driven in rotation and has an axial entrance, or an entrance which is at least in the vicinity of the axis, for the material intermixed with the grinding bodies.

Using a sedimentation centrifuge for separating off the grinding bodies makes it possible to dispense with slotted screens, and the associated problems do not arise. In relation to the grinding bodies being separated off using classifying wheels, there is the advantage that, on account of the product/grinding-body mixture which is to be separated being fed axially, or in the vicinity of the axis, the mixture need not be fed counter to an elevated pressure produced by the classifying wheel acting as a centrifugal pump. The sedimentation centrifuge serves solely as a separating means without the afore-mentioned pumping action. The agitator ball mill can be set up and operated both horizontally and vertically (and basically also in a direction other than these two directions). It would even be conceivable to have cases in which the agitator and the centrifuge can be arranged at an angle relative to one another, in particular at right angles to one another.

In one embodiment, the sedimentation centrifuge has an essentially cup-like outer rotor and a coaxial inner rotor which is connected to the outer rotor in a rotationally fixed manner, wherein an essentially annular centrifuge chamber is located between the outer rotor and the inner rotor.

In a further embodiment, the inner rotor is connected to a base part of the outer rotor via a coaxial separator tube, and the separator tube is provided along its circumference with through-openings for ground material. The sedimentation centrifuge can advantageously be driven in rotation via a hollow shaft which is led through an end wall of the grinding chamber, and the separator tube opens out coaxially into the hollow shaft.

According to a further embodiment, the outer rotor is provided along its circumference with through-openings for separated-off grinding bodies.

The inner rotor may have, at its end which is directed towards the entrance, a preferably conical surface which forms an annular channel with a radially inwardly directed annular flange of the outer rotor.

According to a further embodiment, the sedimentation centrifuge is designed as a disc separator. At least one preferably conical separator disc is arranged on the separator tube. A plurality of separator discs may be arranged, preferably at equal spacings, on the separator tube, and for the through-openings of the separator tube to be arranged between, and laterally alongside, the separator discs.

According to a further embodiment, the sedimentation centrifuge is designed as a decanter, the inner rotor being of essentially cylindrical design and having a preferably conical end surface.

According to a further embodiment, the agitator and the sedimentation centrifuge are designed such that they can be driven in rotation independently of one another. It is thus possible in particular for the rotational speed and the direction of rotation of the sedimentation centrifuge and of the agitator to be set fully independently of one another. For example, the agitator and sedimentation centrifuge can rotate either in the same direction or in opposite directions and at the same rotational speed or at different rotational speeds. This can be achieved in design terms, for example, in that the sedimentation centrifuge and the agitator each have a separate drive shaft and can each be driven by a separate motor. This allows optimum adaptation to practical operating situations.

According to a further embodiment, the agitator and the sedimentation centrifuge are designed such that they can be driven in rotation together. This can be achieved in design terms, for example, in that the sedimentation centrifuge and the agitator have a common drive shaft and can be driven by a motor which drives the common drive shaft.

A further embodiment provides conveying means, in particular in the form of a conveying screw fitted on the outer rotor, which allow grinding bodies which have passed out of the sedimentation centrifuge to be conveyed back into the grinding space of the grinding chamber containing the agitator.

According to a further embodiment, the agitator ball mill has a deflecting means which is arranged, at least in part, around the at least one agitating means. By way of this deflecting means, the material which is to be ground or dispersed is directed into that part of the grinding chamber which extends directly around the agitating means. According to one embodiment, the deflecting means may be static, for example it may be arranged at a fixed location in the grinding chamber, e.g. it may be fixed on the inner wall of the grinding chamber. According to another embodiment, the deflecting means may be dynamic, for example formed by a continuation of the outer rotor of the sedimentation centrifuge.

A further advantageous embodiment provides, in the grinding chamber, an additional inlet for feeding in additional product suspension or liquid phase of the product suspension and/or dispersant, in order to reduce the pronounced increase in viscosity which can occur, in particular, in nanosuspensions.

According to a further embodiment, the inlet or the additional inlet is arranged at the agitator end of the grinding chamber or at the centrifuge end of the grinding chamber.

### BRIEF DESCRIPTION OF DRAWINGS

The agitator ball mill will be described in more detail herein below by way of four exemplary embodiments and with reference to the accompanying drawing, in which:

FIG. 1 shows an axial section through a first embodiment of the agitator ball mill,

FIG. 2 shows an axial section through a second embodiment of the agitator ball mill,

FIG. 3 shows an axial section through a third embodiment of the agitator ball mill, and

FIG. 4 shows an axial section through a fourth embodiment of the agitator ball mill.

### DETAILED DESCRIPTION

The following applies to the description hereinbelow: If, in order to avoid ambiguity in the drawing, a figure contains reference signs which are not mentioned in the directly associated part of the description, then reference is made to those portions where they are explained in previous or following parts of the description. Moreover, as far as those arrows in a figure which represent the stream of grinding material and/or of grinding bodies are concerned, the intensity of the hatching of the arrows is representative of the proportion of grinding bodies contained in the stream: that is to say, the more pronounced the hatching of an arrow (the darker an arrow appears), the more grinding bodies are contained in the stream. A stream which is represented by an arrow which is not hatched (appears light in colour) thus does not contain any grinding bodies, whereas a stream which is represented by an arrow with pronounced hatching (which appears dark in colour) contains a very large number of grinding bodies.

Furthermore, for the sake of simplicity, the material which is fed to the agitator ball mill for grinding will be referred to hereinbelow as grinding material and the material which has been ground and suspended, and freed from grinding bodies, by the grinding operation will be referred to as product.

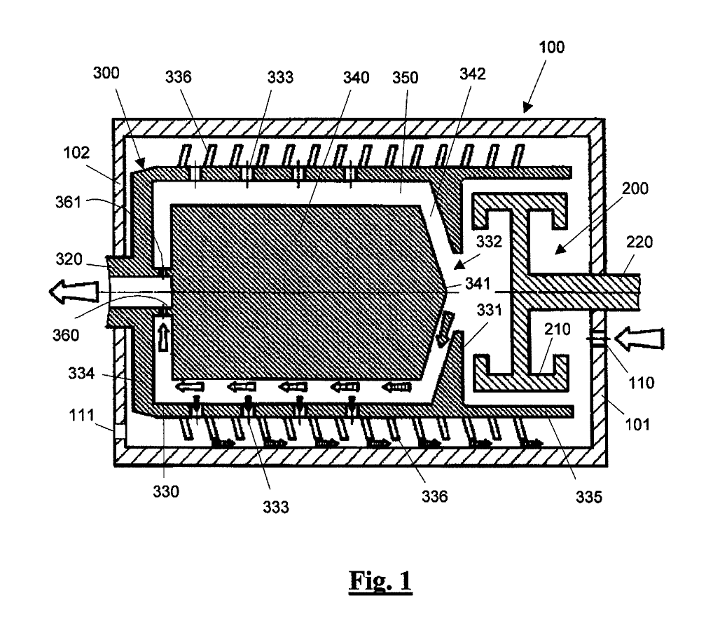

The first embodiment of the agitator ball, being illustrated in FIG. 1, comprises a usually essentially rotationally symmetrical, for example cylindrical grinding chamber 100, in which an agitator 200 and a separating arrangement in the form of a sedimentation centrifuge 300 are arranged.

The agitator 200, which is designed conventionally per se, comprises an agitating means 210 which is seated on an agitating shaft 220 which is led through an end wall 101 of the grinding chamber 100 and can be driven in rotation by a drive motor (not illustrated). The agitator 200 may also be provided, in a manner known per se, with a plurality of agitating means, possibly also of different designs (e.g. paddle wheels, discs, etc.).

The sedimentation centrifuge 300 is seated on a hollow shaft 320 which is led through the other end wall 102 of the grinding chamber 100 and can be driven in rotation by a drive motor (not illustrated either). It is preferable, but not imperative, for the agitator 200 and the sedimentation centrifuge 300 to be oriented coaxially. During practical operation of the agitator ball mill, both the agitator 200 and the sedimentation centrifuge 300 may be positioned horizontally or vertically.

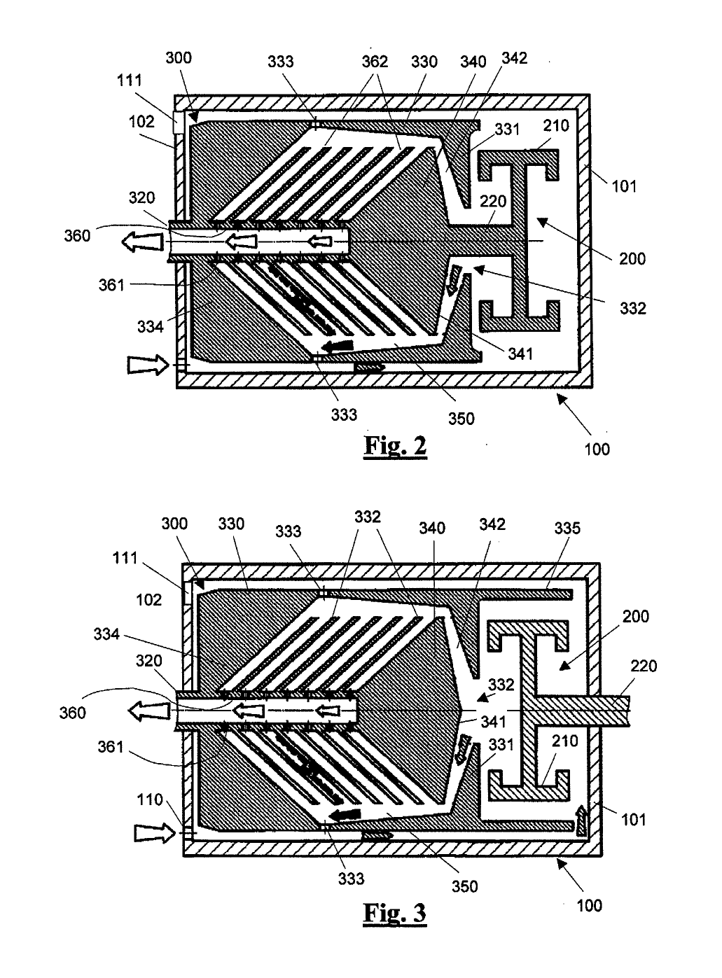

In the embodiments of FIGS. 1, 3 and 4, the agitator 200 and the sedimentation centrifuge 300 can be motor-driven independently of one another. In the embodiment of FIG. 2, the agitator ball mill 220, rather than being led outwards through the end wall 101, is connected in a rotationally fixed and/or integral manner with the sedimentation centrifuge 300, and therefore the agitator 200 rotates synchronously with the sedimentation centrifuge 300. Driving the agitator 200 and sedimentation centrifuge 300 separately using separate motors provides more degrees of freedom. Thus, for example, the sedimentation centrifuge can be operated at a higher rotational speed than the agitator, in order to accelerate the sedimentation of the grinding bodies correspondingly. It is also possible for the agitator 200 and sedimentation centrifuge 300 to be driven in opposite directions of rotation, as a result of which the grinding material is subjected to a shearing action, which can assist the grinding operation.

The sedimentation centrifuge 300 comprises an outer rotor 330, which is essentially in the form of a cylindrical cup, and an inner rotor 340, which is arranged coaxially within the outer rotor, wherein an essentially annular centrifuge chamber 350 is formed between the outer rotor 330 and the inner rotor 340.

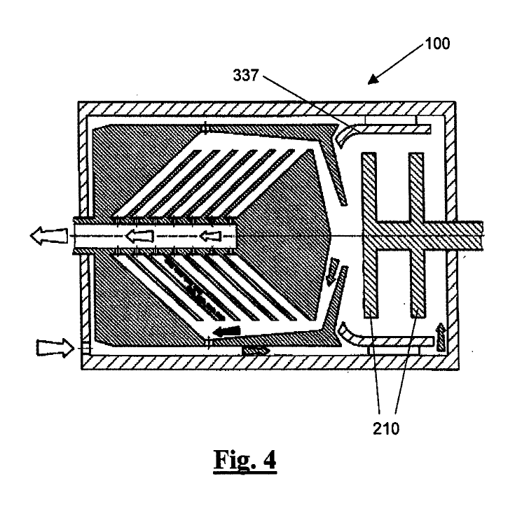

The outer rotor 330 is provided, at its agitator end or just upstream thereof, with a radially inwardly projecting annular flange 331 with an axial opening 332 which forms a centrifuge entrance. The circumferential wall of the outer rotor 330 is interrupted at numerous locations by through-openings 333 which are of sufficient dimensions for grinding bodies to be able to flow through them, out of the centrifuge chamber 350 of the sedimentation centrifuge 300, into the enclosing space of the grinding chamber 100. In the embodiments of FIGS. 1 and 3, the outer rotor 330 is provided with a coaxial tubular extension 335 which projects axially beyond the centrifuge entrance 332 into the grinding or agitating space of the grinding chamber 100 and encloses the agitator 200. The tubular extension 335 may also be provided with a deflecting ring (not illustrated) or it can operate as such (deflecting means). There is no such extension illustrated in the embodiment of FIG. 2.

The inner rotor 340 is fixed at the hollow-shaft end, by means of a coaxial separator tube 360, to the base region 334 of the outer rotor 330. The separator tube 360 runs coaxially in relation to the hollow shaft 320 and opens out into the same. The wall of the separator tube 360 contains a plurality of through-openings 361 through which the product located in the sedimentation centrifuge 300 can flow into the separator tube 360 and, from the latter, into the hollow shaft 320. The hollow shaft 320 of the sedimentation centrifuge 300 thus forms a product outlet for the agitator ball mill.

In the embodiment of FIG. 1, in which the sedimentation centrifuge is designed as a decanter, the inner rotor 340 is essentially cylindrical with a preferably conical tip which is directed towards the centrifuge entrance 332 and of which the end surface (cone surface) is designated 341. The outer rotor 330 has arranged on its lateral surface a conveying screw 336, which reaches into the extension 335 of the outer rotor 330.

In the embodiments of FIGS. 2, 3 and 4, the inner rotor 340 is of essentially double-coned design and is considerably shorter in the axial direction than the inner rotor of FIG. 1. For this reason, the separator tube 360 is correspondingly longer. The end surface (cone surface) of the tip of the inner rotor 340, the tip being directed towards the centrifuge entrance 332, is designated 341. The base part 334 of the outer rotor 330 is conical on its inside, wherein the cone angles of the base part 334 and of the separator-tube-end conical portion of the inner rotor 340 are essentially equal. Between the conical base part 334 of the outer rotor 330 and the inner rotor 340, a plurality of conical separator discs 362 are arranged coaxially, essentially at equal spacings, on the separator tube 360 or are formed integrally with the separator tube 360. The through-openings 361 in the wall of the separator tube 360 are distributed over the length of the separator tube 360, and therefore in each case at least one through-opening 361 is located between the separator discs 362, on the one hand, and also between the first and the last separator discs and the inner rotor 340 and the base part 334 of the outer rotor 330. In these embodiments, the sedimentation centrifuge is thus constructed essentially in the manner of a disc separator.

In the embodiment of FIG. 1, an inlet 110 for grinding material is provided in the agitator-end end wall 101 of the grinding chamber 100 (at the agitator end). The ground or dispersed product is led away through the hollow shaft 320 at the opposite end of the grinding chamber 100. In the embodiments of FIGS. 2, 3 and 4, the inlet 110 for the grinding material is located in the hollow-shaft-end end wall 102 of the grinding chamber 100, the product, once again, being led away through the hollow shaft 320.

General functioning of the agitator ball mill is as follows: The grinding material is introduced into the grinding chamber 100 through the inlet 110 and is ground and suspended in the agitator 200 by the grinding bodies present there. The mixture of ground material and grinding bodies passes through the axial centrifuge entrance 332 into the interior 350 of the sedimentation centrifuge 300. The grinding bodies are separated off there by being centrifuged radially outwards by the centrifugal action of the rotating sedimentation centrifuge. The grinding bodies pass back into the grinding chamber through the through-openings 333 of the outer rotor 330 and are flushed back to the agitator 200. The product freed from the grinding bodies flows through the through-openings 361 into the separator tube 360 and is led away from the latter into the hollow shaft 320 and is led away through this hollow shaft.

In the embodiments of FIGS. 2, 3 and 4, the grinding material fed through the inlet 110 flows, on route to the agitator 200, around the outer rotor 330 of the sedimentation centrifuge 300. Grinding bodies pass out of the outer rotor 330 through the through-openings 333 thereof. These grinding bodies are entrained by the inflowing grinding material and are conveyed back to the grinding space, in which are located the agitator 200 and most of the grinding bodies.

Following the grinding operation, the product/grinding-body mixture enters, through the entrance 332 of the sedimentation centrifuge 300, into the sedimentation centrifuge, to be precise the space between the agitator 200 and the outer rotor 330, along its axis, or in the vicinity of its axis. The product/grinding-body mixture which has entered is accelerated on account of the centrifugal force. The cross-sectional surface area of the centrifuge chamber 350 between the outer ends of the separator discs 362 and the inner wall of the outer rotor 330, flow taking place along this cross-sectional surface area, widens advantageously outwards, and therefore the flow can moderate itself in order to achieve, as far as possible, laminar flow with reduced speed, and thus to facilitate the sedimentation of the grinding bodies on the inner wall of the outer rotor 330, and therefore the smallest possible number of grinding bodies are carried along between the separator discs 362. Nevertheless, grinding bodies which are carried along between the separator discs 362 are centrifuged outwards and collect, along with the already accumulated grinding bodies, on the inner wall of the outer rotor 330, in order then to pass through the through-openings 333 and to be conveyed back to the agitating means with newly fed-in grinding material. The interspaces (disc channels) between the separator discs 362 are advantageously likewise configured so as to achieve, as far as possible, a laminar flow. The number of separator discs 362 can be selected in accordance with the desired throughput. The product freed from the grinding bodies passes through the through-openings 361 into the separator tube 362 and from there, via the hollow shaft 320, to the product outlet.

An additional inlet 111 may optionally be provided at the other end (centrifuge end) of the grinding chamber 100, on the same side as the hollow shaft 320. It is possible here to inject in additional product suspension, or also the liquid phase of the product suspension and possibly also a dispersant, in order to reduce the pronounced increase in viscosity which occurs, in particular, in nanosuspensions.

In the embodiment of FIG. 1, the sedimentation centrifuge 300 acts essentially as a decanter. The grinding bodies are centrifuged outwards from the inner rotor 340 and pass out through the through-openings 333 in the outer rotor 330. The grinding bodies which have passed out are conveyed back into the grinding space by the conveying screw 336, which is fitted on the outer rotor 330. It is also possible in this embodiment for an additional inlet 111 to be provided at the other end of the grinding chamber 100, on the same side as the hollow shaft 320, it being possible for additional product suspension, or also the liquid phase of the product suspension and/or a dispersant, to be injected in through this additional inlet in order to reduce the pronounced increase in viscosity which occurs, in particular, in nanosuspensions.

According to a variant, the agitator 200 or the agitating means 210 thereof may be enclosed by a deflecting ring which influences the flow conditions in the grinding space. The deflecting ring may be static or dynamic, in which case it may be fastened on the outer rotor and would rotate along therewith. The agitating means may be designed in various forms, e.g. as paddle wheels, discs or in some other way. It is possible here for just one agitating means, or more than one agitating means, to be provided on the agitator shaft.

The fourth embodiment of the agitator ball mill according to the invention, this embodiment being shown in FIG. 4, has a certain similarity to the embodiment shown in FIG. 3. However, in the embodiment according to FIG. 4, a fixed-location deflecting ring 337 is fixed, as deflecting means, to the inner wall of the grinding chamber 100. The fixed-location deflecting ring 337 is arranged around the agitating means 210, which in this case are designed, for example, in the form of discs. It is also the case that the embodiment according to FIG. 4 does not illustrate the optional inlet opening 111; it may or may not be present. As far as the functioning of the embodiment according to FIG. 4 is concerned, reference is made to the above description of the functioning of the embodiment according to FIG. 3.

Numerous other variants which are common practice for a person skilled in the art are conceivable in relation to the above-described embodiments of the agitator ball mill. In particular, it is possible, for example, for the drive of the agitator and of the sedimentation centrifuge to be realized in various ways and for the agitator and the sedimentation centrifuge to be modified in various ways without departing from the framework of the invention. Examples of agitating means which may be used are thus paddle wheels, discs or other suitable agitating means. The invention has been described with reference to the above-described embodiments of the agitator ball mill. However, the invention should not be understood as being limited to these embodiments. Rather, numerous modifications to, and variants of, such an agitator ball mill are conceivable without departing from the technical teaching. For example, the grinding bodies can also be conveyed back by other conveying means, e.g. paddle wheels, or the sedimentation centrifuge may be designed as a tubular centrifuge. Furthermore, it is also possible, for example, for the grinding space in which the agitator is located to be partially delimited from the sedimentation centrifuge by a centrally open intermediate wall in the grinding chamber.

What is claimed is:

1. An agitator ball mill for finely grinding or dispersing a material, having a preferably rotationally symmetrical grinding chamber for accommodating grinding bodies and for accommodating the material which is to be ground or dispersed, having an inlet for the material which is to be ground or dispersed, having an agitator, which can be driven in rotation and has at least one agitating means by way of which the grinding bodies and the material which is to be ground or dispersed are moved in the grinding chamber, having a separating arrangement for separating off the grinding bodies from the ground or dispersed material, and having a product outlet for the material which has been ground or dispersed and freed from grinding bodies, wherein the ground or dispersed material passes through the separating arrangement into the product outlet, wherein the separating arrangement is designed as a sedimentation centrifuge which can be driven in rotation and has an axial entrance, or an entrance which is at least in the vicinity of the axis, for the material intermixed with the grinding bodies.

2. The agitator ball mill according to claim 1, wherein the sedimentation centrifuge has an essentially cup-like outer rotor and a coaxial inner rotor which is connected to the outer rotor in a rotationally fixed manner, wherein an essentially annular centrifuge chamber is located between the outer rotor and the inner rotor.

3. The agitator ball mill according to claim 2, wherein the inner rotor is connected to a base part of the outer rotor via a coaxial separator tube.

4. The agitator ball mill according to claim 3, wherein the separator tube is provided along its circumference with through-openings for the ground or dispersed material.

5. The agitator ball mill according to claim 4, wherein the sedimentation centrifuge can be driven in rotation via a hollow shaft which is led through an end wall of the grinding chamber, and in that the separator tube opens out coaxially into the hollow shaft.

6. The agitator ball mill according to claim 2, wherein the outer rotor is provided along its circumference with through-openings for separated-off grinding bodies.

7. The agitator ball mill according to claim 2, wherein the inner rotor has, at its end which is directed towards the entrance, a preferably conical end surface which forms an annular channel with a radially inwardly directed annular flange of the outer rotor.

8. The agitator ball mill according to claim 1, wherein the sedimentation centrifuge is designed as a disc separator.

9. The agitator ball mill according to claim 3, wherein at least one preferably conical separator disc is arranged on the separator tube.

10. The agitator ball mill according to claim 9, wherein a plurality of separator discs are arranged, preferably at equal spacings, on the separator tube, and wherein the through-openings of the separator tube are arranged between, and laterally alongside, the separator discs.

11. The agitator ball mill according to claim 1, wherein the sedimentation centrifuge is designed as a decanter, the inner rotor being of essentially cylindrical design and having a preferably conical end surface.

12. The agitator ball mill according to claim 1, wherein the agitator and the sedimentation centrifuge are designed such that they can be driven in rotation either independently of one another or together.

13. The agitator ball mill according to claim 1, wherein the provision of conveying means which allow grinding bodies which have passed out of the sedimentation centrifuge to be conveyed back into the grinding space of the grinding chamber containing the agitator.

14. The agitator ball mill according to claim 1, further having a deflecting means which is arranged, at least in part, around the at least one agitating means, wherein the deflecting means is either static, e.g. is arranged at a fixed location in the grinding chamber, or dynamic, e.g. is formed by an extension of the outer rotor of the sedimentation centrifuge.

15. The agitator ball mill according to claim 1, further comprising, in the grinding chamber, an additional inlet for feeding in additional product suspension or liquid phase of the product suspension and/or dispersant.
